(19) United States
(12) Patent Application Publication
(10) Pub. No.: US 2004/0186808 A1
(43) Pub. Date: Sep. 23, 2004

(54) A BUSINESS METHOD FOR ENCOURAGING THE ACQUISITION OF A VEHICLE

(75) Inventor: William J. Coughlin, Harrison Township, MI (US)

Correspondence Address: FORD GLOBAL TECHNOLOGIES, LLC., SUITE 600 - PARKLANE TOWERS EAST, ONE PARKLANE BLVD., DEARBORN, MI, 48126, US

(73) Assignee: FORD GLOBAL TECHNOLOGIES, LLC., Dearborn, MI (US)

(21) Appl. No.: 10/249,138

(22) Filed: Mar. 18, 2003

(51) Int. Cl. G06F 17/60

(52) U.S. Cl. 705/40

(57) ABSTRACT

A business method and system for encouraging the acquisition of a vehicle that features an offer to make a plurality of periodic payments of at least two types in the event that a predetermined reduction of income event occurs within a predetermined time. One of these payment types is directly related to the acquisition of the vehicle. A second payment type is designed to enhance the financial security of the consumer in combination with the first payment type in a way that will provide substantial value to the consumer and instill positive consumer confidence. In other words, by acquiring a vehicle, such as by purchase or lease, the consumer will be in a more secure financial condition than the consumer would otherwise be if the vehicle were not acquired. For example, the first payment type could be a vehicle loan or lease payment, while the second payment could be a mortgage or rent payment. Insurance is also provided in order to appropriately spread the risk incurred with the incentive plan according to the present invention.

### BACKGROUND AND SUMMARY OF THE INVENTION

The present invention relates generally to the sale or lease of vehicles, and particularly to a method and system for encouraging consumers to buy or lease vehicles.

It is well established that automobile sales are highly correlated to consumer confidence. Thus, when consumer confidence decreases, the overall sales volume of new automobiles will decrease as well. This cyclical pattern has persisted for decades. In recent years, automobile sales have been spurred on by significantly increased incentives, such as zero percent interest financing and cash rebates up to several thousand dollars. However, the power of these significant incentives to drive automobile sales has been losing their impact in the face of decreasing consumer confidence. In other words, the cyclical pattern still persists and has remained unsolved.

Accordingly, it is a principal objective of the present invention to provide a business method and system for encouraging the acquisition of a vehicle, even when consumer confidence is decreasing.

It is another objective of the present invention to provide a business method and system for encouraging the acquisition of a vehicle that can substitute, at least in part, for more expensive incentives, while still providing substantial value for consumers.

It is a further objective of the present invention to provide a business method and system for encouraging the acquisition of a vehicle that could also potentially create a new income stream for vehicle dealers.

To achieve the foregoing objectives, the present invention provides a business method and system for encouraging the acquisition of a vehicle that features an offer to make a plurality of periodic payments of at least two types in the event that a predetermined reduction of income event occurs within a predetermined time. One of these payment types is directly related to the acquisition of a vehicle, and it is designed to help boost a consumer's confidence. A second payment type is designed to enhance the financial security of the consumer in combination with the first payment type in a way that will provide substantial value to the consumer and instill positive consumer confidence in an economic downturn. In other words, by acquiring a vehicle, such as through a purchase or lease, the consumer will be in a more secure financial condition than the consumer would otherwise be if the vehicle were not acquired. For example, the first payment type could be a vehicle loan or lease payment, while the second payment could be a mortgage or rent payment.

In order to appropriately spread the risk incurred with the incentive program according to the present invention, the risk represented by a reduction of income event should be insured for at least the dealer or retail level. While the risk of a reduction in income event could be self insured by an original equipment manufacturer of vehicles, this risk is preferably insured through one or more insurance companies that have expertise in appropriately pricing for insurable risks.

In one form of the present invention, the plurality of periodic payments made as a result of a reduction of income event total an amount which is substantially less than the outstanding balance of the vehicle loan or lease payment. Thus, for example, in one incentive program according to the present invention, monthly vehicle loan payments are provided for up to one year in response to a reduction of income event, such as a job loss or layoff, when the vehicle loan has a three to five year duration. This gap in coverage could then be used to create an income stream for vehicle dealers by enabling them to sell one or more sets of timed extensions of an incentive plan in accordance with the present invention.

Further advantages and features of the present invention will be seen from the detailed description of the drawings, which are summarized briefly below:

### BRIEF DESCRIPTION OF DRAWINGS

FIG. 1 is a diagrammatic illustration of the business method and system for encouraging consumers to buy or lease vehicles according to the present invention.

FIG. 2 is a flow chart of a transaction process that includes the business method for encouraging consumers to buy or lease vehicles according to the present invention.

### DETAILED DESCRIPTION

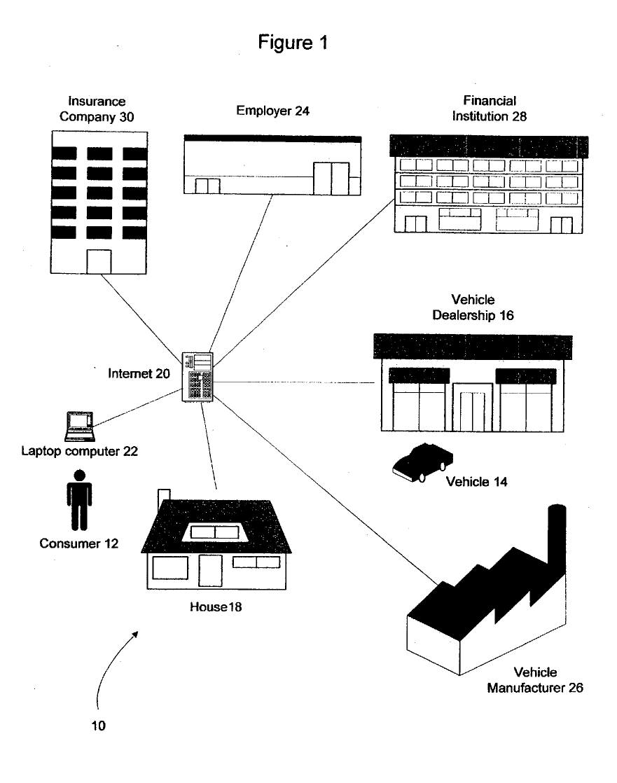

Referring to FIG. 1, a diagrammatic illustration of a business method and system 10 for encouraging the acquisition of a vehicle according to the present invention is shown. In this regard, it is assumed that a consumer 12 wishes to purchase or lease a vehicle 14 from an vehicle dealership 16. The consumer 12 resides in a house or apartment 18, and he or she preferably has access to the Internet 20 through a personal computer or laptop computer 22. The consumer 12 may work at an employer 24 or be a self employed contractor or professional. The vehicle dealership 16 may be a new vehicle dealership associated with one or more vehicle manufacturers, such as vehicle manufacturer 26. The vehicle dealership 16 may also be a used vehicle dealership or have a used vehicle business in conjunction with the sale of new vehicles. The vehicle 14 may be any passenger vehicle that a consumer would purchase or lease, such as an automobile sedan, minivan, pickup truck, sport utility vehicle or crossover vehicle. Alternatively, vehicle 14 could be a boat, a camper, motorcycle, snowmobile, jet ski or other passenger conveying device where multiyear financing is typically needed in order for most consumers to afford a vehicle acquisition and where a downturn in the economy can significantly impact acquisition transactions.

There may be other ways for the consumer 12 to acquire automobile 14 besides a purchase or lease. However, it should be appreciated that the principles of the present invention are not limited to any particular type of financial transaction, aside from the existence of some form of periodic installment payments that must be made over time in order to maintain possession and/or use of the vehicle. In the event that the vehicle 14 is acquired through a loan or a lease, a financial institution 28 is generally used to provide the underlying funding for the transaction. Financial institution 28 may be a captive financial operation of the vehicle manufacturer 26, a bank, a credit union or any other suitable entity in the business of providing funding for consumer purchases and/or leases.

An insurance company 30 is also shown in shown in FIG. 1, but not for the usual purpose for insuring an vehicle owner or user against liability for an accident, theft or the like. Rather, in accordance with the present invention, insurance company 30 is provided to insure against the risk of a reduction of income event that materially impacts the financial condition of consumer 12. A reduction of income event could result from a termination of employment, a temporary or permanent layoff, a salary reduction, or other such involuntary reductions of employment or contracted income. In other words, the risk being insured should not operate as a reason to quit working, retire or otherwise forego reemployment. While the insurance company 30 and most of the other entities or locations described above are shown to be connected to the Internet 20, it should be understood that Internet connectivity is not necessarily essential to the present invention. Rather, connectivity to the Internet 20 facilitates the efficiency of a computer-implemented embodiment according to the present invention.

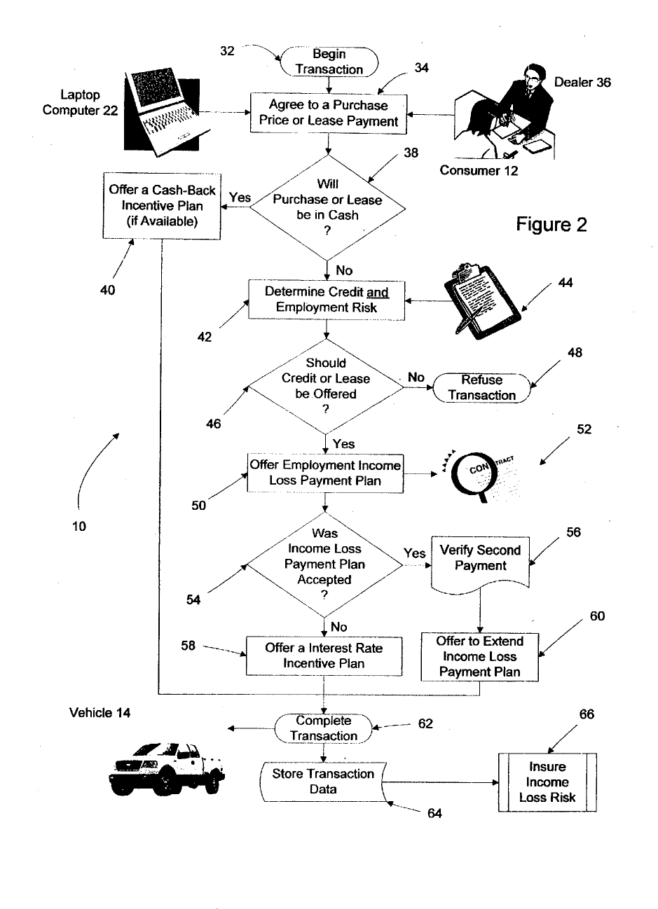

Referring to FIG. 2, a flow chart of a transaction process is shown that includes the business method 10 according to the present invention. The transaction process begins (step 32) following the selection of a vehicle by the consumer 12, such as by browsing the Internet site of dealership 16 using laptop computer 22. Once the vehicle 14 has been selected, a purchase price or lease payment is then negotiated or agreed to (step 34). In this regard, it should be appreciated that the present invention is also equally applicable to acquisition transactions in which the purchase price is fixed in advance and not varied in a “no haggle” dealership setting. A decision is then made as to whether the vehicle 14 will be purchased or leased entirely in a single cash payment (step 38). If the consumer 12 elects to use cash, then a cash rebate incentive could electively be offered pursuant to a conventional incentive program if desired (step 40).

In the event that financing or installment payments will be used, the consumer's credit risk and employment risk are then analyzed according to the present invention (step 42). This determination is predicated upon the consumer 12 filling out an appropriate application 44, either online or on paper. However, it should be appreciated that a select group of consumers could be pre-approved or a determination made from existing database information on the consumer's financial and employment condition. Preferably, the application 44 will include one or more representations about the consumer's current employment status. Alternatively, or in combination with such representations, the business method 10 could withhold the intended payment benefits for a predetermined period of time. For example, the payment benefits could be denied if a reduction of income event occurs within the first 30 or 60 days following the vehicle acquisition.

If a determination is made not to finance or offer installation payments (step 46), then the transaction should be refused, unless of course the consumer then decides to fund the acquisition with cash (step 48). Otherwise, in accordance with the present invention, an offer is made to make a plurality of periodic payments for the consumer 12 in the event that a predetermined reduction of income event occurs within a predetermined time (step 50). This offer should be embodied in a written contract 52. The predetermined reduction of income event need not be a complete loss of the consumer's employment or contract income. For example, in one embodiment according to the present invention, a salary reduction of 20% or more could be sufficient to trigger the periodic payments to be made on behalf of the consumer.

While the periodic payments made under the contract 52 could precisely correspond to or be directly related to the periodic payments under the vehicle loan or lease, the business method 10 provides for payments of two types. In order to turn a decrease in consumer confidence around to a definitive positive that could even help lead to an increase in consumer confidence, at least one more appropriate payment type is incorporated into the present invention. This payment type should be significant enough to make a meaningful difference to the consumer. Accordingly, in one form of the present invention, this second payment type is a home mortgage or rent payment. Thus, for example, the consumer 12 would be able to achieve important financial security for the two most expensive obligations typically incurred by nearly all consumers through the present invention.

Assuming that the contract 52 is accepted (step 54), it is preferable, but not necessarily essential, in all circumstances that the second payment type be verified (step 56). For example, in the case of a home mortgage payment, a copy of the mortgage or verification from the mortgagor could be provided at the time of the transaction or within in a seasonable time thereafter. Depending upon the sales need and the model of vehicle being acquired, the dealer 36 or the vehicle manufacturer 26 may also provide the consumer with an interest rate incentive as well (step 58). However, one of the advantages of the present invention is that the income loss payment plan can be used as a partial or complete substitute for other more costly sale incentives, while still providing excellent value for the consumer 12. In this regard, it should be appreciated that substantial consumer loyalty to the brand of vehicle acquired should result, as financial security is being provided in addition to the vehicle itself.

The dealer 36 may also offer to extend the duration of the income loss payment plan represented by contract 52 (step 60). This option of the business method 10 effectively creates a new income stream for the dealership 16. In other words, the present invention not only operates to increase the volume of vehicle sales or leases at the dealership 16, but it also simultaneously adds to the income base of the dealership through profitable extensions of the financial security coverage for the consumer 12. Thus, for example, the dealership 16 could sell additional increments of individual years of coverage up to the entire duration of the periodic vehicle loan or lease payments. Given that many consumers will replace their vehicles before paying off the vehicle loan, these extensions of time should be profitable for the dealership 16.

Once the transaction is complete (step 62), the transaction data should be stored in a computer database (step 54). Lastly, and importantly, the dealership 16 should not bear the entire economic risk of income loss payment plan according to the present invention. While the vehicle manufacturer 26 could self insure this risk, it is preferred that one or more companies in the business of insuring risk contract with either the vehicle manufacturer 26 or the dealership 16 to appropriately spread the risk at a profit for the insurer (step 66).

The business method 10 is particularly well suited as a computer-implemented process. For example, the business method 10 could be advertised in a number of ways including sending an email or computer generated mailing to previous consumers of a particular vehicle brand whose vehicle age would indicate a high likelihood that these consumers should soon be in the market for a replacement vehicle. Depending upon the financial and employment information on a consumer that may be available to the dealership 16 or the vehicle manufacturer 26, the consumer 12 may be pre-approved for business method 10 or approved through an interactive Internet site maintained by the dealership or the vehicle manufacturer. Thus, for example, if the consumer 12 is employed at a major corporation or a particular kind of professional, the application and approval process may be substantially simplified in concert with the standards for insurance provided by insurance company 30. Conversely, if a corporation announces that a significant layoff will take place, then this information could be incorporated into the database system for calculating insurance risk. In such a situation, further proof of good employment standing could be required or an exception required for the anticipated layoff event. Alternatively, this information could be calculated into the risk determination and the price of the insurance adjusted accordingly.

While particular embodiments of the invention have been shown and described, numerous variations and alternate embodiments should occur to those skilled in the art. Accordingly, it is intended that the invention be limited only in terms of the appended claims.

1. A method of encouraging a consumer to acquire a vehicle, comprising the steps of:
offering to make a plurality of periodic payments of at least two types, one of said payment types being directly related to the acquisition of said vehicle, in the event that a predetermined reduction of income event occurs within a predetermined time; and
insuring that risk represented by said predetermined reduction of income event.

2. The method according to claim 1, wherein said predetermined reduction of income event comprises an involuntary loss of employment income.

3. The method according to claim 2, wherein a first one of said payments types is a vehicle loan or lease payment, and a second one of said payment types is a home mortgage or rental payment.

4. The method according to claim 3, wherein said plurality of periodic payments total an amount which is substantially less than the outstanding balance of said vehicle loan or lease payment.

5. The method according to claim 4, including the further step of offering said consumer the opportunity to purchase an extension of said plurality of periodic payments.

6. The method according to claim 1, wherein said offer is made as an alternative, at least in part, in lieu of a cash or interest rate incentive for encouraging said consumer to acquire said vehicle.

7. A system for encouraging a consumer to acquire a vehicle, comprising:
means for determining the credit and employment risk of said consumer;
means for generating an offer to make a plurality of periodic payments of at least two types, one of said payment types being directly related to the acquisition of said vehicle, in the event that a predetermined reduction of income event occurs within a predetermined time; and
means for insuring the risk represented by said offer in response to acceptance.
